(19) United States
(12) Patent Application Publication
(10) Pub. No.: US 2010/0279127 A1
(43) Pub. Date: Nov. 4, 2010

(54) Highly Viscous Material Coating Applicator

(76) Inventors: Masaki Ukai, Osaka (JP); Koichiro Masunaga, Osaka (JP); Takayuki Ooki, Osaka (JP)

Correspondence Address: JACOBSON HOLMAN PLLC, 400 SEVENTH STREET N.W., SUITE 600, WASHINGTON, DC, 20004, US

(21) Appl. No.: 11/991,783

(22) PCT Filed: Sep. 13, 2005
(86) PCT No.: PCT/JP2005/016838

§ 371 Date: Jul. 12, 2010

(51) Int. Cl. B05D 7/14; B05B 12/08; B05D 5/00; B05B 1/00; B05C 9/08; B05C 9/12; B05D 3/04; B05D 3/02; B05C 9/14; B67D 7/58; B32B 15/00

(52) U.S. Cl. 428/457; 118/58; 118/692; 118/696; 427/348; 427/421.1; 427/372.2; 222/251

(57) ABSTRACT

The present invention provides a coating apparatus capable of coating an object with a highly viscous material at high precision in the applied amount of the highly viscous material and uniformity in the shape of the applied highly viscous material layer. The present invention relates to a coating apparatus capable of coating an object such as the metal sheet of an automobile body with a highly viscous material such as a coat type metal sheet-reinforcing material, at high precision in the applied amount (or the thickness of the applied material layer) and uniformity in the shape of the applied viscous material layer, so as to ensure the reliable reinforcing effect of the reinforcing material. The present invention also pertains to a coating method using the same apparatus, and a coated article provided by using the same apparatus.

### TECHNICHAL FIELD

The present invention relates to a coating apparatus for a highly viscous material. In particular, the present invention relates to a coating apparatus capable of coating the metal sheet of an automobile body with a highly viscous material such as a coat type metal sheet-reinforcing material at high precision in uniformity in the coating amount (or the thickness of a coating) and the shape of applied coating layer, etc. in order to obtain a reliable reinforcing effect. The invention also pertains to a coating method using the same apparatus, and a coated article obtained by using the same apparatus.

### BACKGROUND OF THE INVENTION

The reinforcement of the metal sheets of automobile bodies are made in order to ensure the rigidity and dent prevention of the metal sheets, which become thinner in thickness in association with the weight reduction of the automobile bodies, or in order to ensure the safety thereof against a bump. This reinforcing effect can be obtained as follows: a reinforcing material which is usually a highly viscous material (in general under heating by way of a heat hose or the like) is fed to a coating gun; and the reinforcing material is band-like (or bead-like) applied to the metal sheet of an automobile body from the slit nozzle of the coating gun and is then heated and cured to form a desired reinforcing material layer on the metal sheet.

### DISCLOSURE OF THE INVENTION

### Problems to be Solved by the Invention

However, the above coating steps suffer from the following problems left to be unsolved.

i) When a reinforcing material is band-like applied to the inclined face, vertical face or ceiling face of the metal sheet of an automobile body, it is not rare that the layer of the applied reinforcing material peels (or floats) from the edge portions of the band-like applied reinforcing material layer due to its own weight.

While a constant-flow pump excellent in volumetric discharge feeding is used to uniform the coating amount, such a pump causes the following disadvantages when it is started for coating.

ii) The coating amount (or the thickness of the coating) is not kept constant because of variation in the discharged amount, and the metal sheet is pulled due to the hardening or shrinkage of the reinforcing material so that a strain is more likely to occur in the surface of the metal sheet; or

iii) the shape of the applied reinforcing material layer (band-shaped) can not be kept constant, so that the bead edge portion of the applied reinforcing material degrades in anti-corrosion, which results in a poor reinforcing effect leading to an adverse influence on the external appearance of the automobile body.

In application of a coat type metal sheet-reinforcing material, variation in coating amount and coating shape gives some influences on the reinforcing effect and the strain which occurs in the metal sheet after the reinforcing material has been hardened, and therefore, higher coating precision is needed for the metal sheet-reinforcing material than general-purpose adhesives and sealing materials.

To solve the problems (ii) and (iii), for example, there are proposed a coating apparatus for a viscous material, comprising a coating gun equipped with a pressure-adjusting valve which adjusts a discharge pressure from a nozzle to thereby control the discharged amount of the viscous material, and a pressure sensor for detecting the discharge pressure (cf. Patent Publication 1); and a coating gun for bead-like application of a reinforcing material, in which the tip end portion of the nozzle is provided with a jig for adjusting the shape of beads so as to adjust the shape of the section of a reinforcing material layer (cf. Patent Publication 2).

Patent Publication 1: JP-A-5-293413 (refer to page 1)

Patent Publication 2: JP-A-7-256179 (refer to page 1)

### Means for Solving Problems

The present inventors have intensively studied in order to solve the foregoing problems (i) to (iii) by methods different from those of the prior art, and found that the respective problems can be solved by the following means.

To prevent the peeling (or floating) of the reinforcing material in the problem (i), a gas injector is provided to inject a gas simultaneously with or immediately after the application of a highly viscous material to thereby fix the highly viscous material.

To prevent the variation of the discharged amount in the problem (ii), a means for enabling an automatic switching operation of the constant flow pump is provided so as to adjust the inner pressure of a hose on the discharge side of the constant flow pump to a predetermined target value at the start of coating.

To maintain the shape of the applied reinforcing material layer in the problem (iii), a slit nozzle having a special configuration is used with a coating gun.

The present invention is accomplished based on such findings.

The following are the preferred embodiments of the present invention.

[1] A coating apparatus for band-like applying a highly viscous material to an object, the apparatus comprising at least a hose, a pump and a coating gun having a slit nozzle, wherein the coating gun is provided with a gas injector which fixes the highly viscous material to the object simultaneously with or immediately after the application of the highly viscous material.

[2] A coating apparatus for band-like applying a highly viscous material to an object, the apparatus comprising at least a hose, a pump and a coating gun having a slit nozzle, wherein a precompression control mechanism is further included which enables an automatic switching operation of the pump by adjusting the value of a measured pressure in the hose on the discharge side of the pump to a preset precompression target value, and wherein the precompression control mechanism comprises at least a controller for the pump.

[3 ] A coating apparatus for band-like applying a highly viscous material to an object, the apparatus comprising at least a hose, a pump and a coating gun having a slit nozzle, wherein the slit nozzle is a parallel nozzle which has a nozzle passage communicating with a radial introduction passage, and extending from an inlet to an outlet with a constant parallel width W and having a constant clearance width S.

[4] The coating apparatus defined in the item [3], wherein the constant parallel width W is from 10 to 100 nm; the constant clearance width S is from 0.5 to 5 mm; and the length L from the inlet 11 to the outlet 12 is from 5 to 30 mm.

[5] A coating apparatus for band-like applying a highly viscous material to an object, the apparatus comprising at least a hose, a pump and a coating gun having a slit nozzle, wherein the coating gun is provided with a gas injector which fixes the highly viscous material to the object simultaneously with or immediately after the application of the highly viscous material; wherein a precompression control mechanism which enables an automatic switching operation of the pump by adjusting the value of a measured pressure in the hose on the discharge side of the pump to a preset precompression target value is further included; wherein the precompression control mechanism comprises at least a controller for the pump; and wherein the slit nozzle is a parallel nozzle which has a nozzle passage communicating with a radial introduction passage, and extending from an inlet to an outlet with a constant parallel width W and having a constant clearance width S.

[6] The coating apparatus defined in any of the items [1] to [5], for use in automatic coating by a robot.

[7] A method for band-like applying a highly viscous material to an object, using the coating apparatus defined in any of the items [1] to [6].

[8] The coating method defined in the item [7], wherein the highly viscous material is a coat type metal sheet-reinforcing material, and the object is the metal sheet of an automobile body.

[9] A reinforced metal sheet structure obtained by applying a reinforcing material to a metal sheet by the method defined in the item [8], and heating and curing the reinforcing material.

[10] A method for manufacturing a coated article, comprising the steps of feeding a highly viscous material to a coating gun 3 through a hose 1 and a pump 2, and band-like applying the highly viscous material to an object from the slit nozzle of the coating gun 3, wherein the method includes a step of fixing the band-shaped highly viscous material layer to the object simultaneously with or immediately after the application of the highly viscous material, using a gas injector attached to the coating gun.

[11] The method defined in the item [10], wherein an automatic switching operation of the pump is performed by adjusting the value of a measured pressure in the hose on the discharge side of the pump to a precompression target value preset via a controller 5 for the pump.

[12] The method defined in the item [10] or [11], wherein the slit nozzle is a parallel nozzle which has a nozzle passage communicating with a radial introduction passage, and extending from an inlet to an outlet with a constant parallel width W and having a constant clearance width S.

### BRIEF DESCRIPTION OF DRAWINGS

FIG. 1 is a schematic diagram of a coating apparatus according to an embodiment of the present invention, illustrating the basic structure thereof and a precompression control mechanism.

FIG. 2, consisting of FIGS. 2(A) and 2(B), schematically shows coating states, wherein FIG. 2(A) shows a coating state when precompression control is not made at the start of coating, and FIG. 2(B) shows a coating state when precompression control is made at the start of coating.

FIG. 3 is a perspective view of an example of a slit nozzle having a special configuration, illustrating the inner structure thereof.

FIG. 4, consisting of FIGS. 4(A) and 4(B), shows the slit nozzle shown in FIG. 3, wherein FIG. 4(A) is a cross-sectional view of the slit nozzle, and FIG. 4, (B) is a longitudinal sectional view thereof.

FIG. 5, consisting of FIGS. 5(A), 5(B) and 5(C), shows front views of slits, wherein FIG. 5(A) is the front view of the slit opening of the slit nozzle shown in FIG. 3, and FIGS. 5(B) and 5(C) are the front views of other slit openings, respectively.

FIG. 6 is a schematic diagram illustrating the fixing state of a highly viscous material by means of a gas injector.

### DESCRIPTION OF REFERENCE NUMERALS

1=a hose
2=a pump
3=a coating gun
4=a pressure transmitter
5=a controller for a pump

### BEST MODES FOR CARRYING OUT THE INVENTION

In a preferred embodiment the present invention relates to a coating apparatus for band-like applying a highly viscous material to an object, which comprises at least a hose, a pump and a coating gun having a slit nozzle, and preferably to a coating apparatus, which feeds a highly viscous material to a coating gun 3 through a hose 1 and a pump 2, and then, band-like applies the highly viscous material to an object from the slit nozzle of the coating gun 3, said coating apparatus being characterized in that

(i) the coating gun 3 is provided with a gas injector which fixes the band-shaped highly viscous material to the object simultaneously with or immediately after the application of the highly viscous material; and/or
(ii) a precompression control mechanism is provided which enables an automatic switching operation of the pump 2 via a controller (e.g., PLC) 5 for the pump, in order to adjust the value of a measured pressure in the hose 1 on the discharge side of the pump 2 at the start of coating, to a preset precompression target value; and/or
(iii) the slit nozzle is a parallel nozzle which has a nozzle passage 13 communicating with a radial introduction passage 10, and extending from an inlet 11 to an outlet 12, with a constant parallel width W and having a constant clearance width S. The present invention also relates to a coating method using the same coating apparatus, and a coated article obtained by using the same coating apparatus.

Examples of the highly viscous material to be used in the present invention may include not only the above-described coat type metal sheet-reinforcing material but also general-use adhesives, coatings, sealing materials, coating materials, soundproof materials, damping materials, etc. As the coat type metal sheet-reinforcing material, for example, reinforcing materials comprising epoxy resins and polyurethane resins as main components as disclosed in JP-A-2002-226995 and JP-A-2003-127897 are exemplified. Especially, a reinforcing material comprising a liquid epoxy, a latent curing agent and a specific amount (20 to 50% by weight) of an inorganic filler in an aspect ratio (L/D) of 5 or more is preferable as the highly viscous material to be used in the present invention.

There is no limit in selection of the kind of the object in the present invention. Examples of the metal sheet of the automobile body to be coated with the above-described coat type metal sheet-reinforcing material include a SPC steel sheet; a steel sheet electroplated with zinc, a steel sheet plated with molten zinc, a steel sheet surface-treated with an organic agent, a steel sheet plated with an alloyed zinc, a steel sheet plated with a zinc-nickel alloy, a steel sheet plated with a tin-lead alloy, cationic type electrodeposited steel sheet, an aluminum sheet, a magnesium sheet, etc.

Hereinafter, a coating apparatus and a coating method using the same apparatus will be described in detail with reference to the accompanying drawings.

In an embodiment according to the present invention, as shown in FIG. 1, a coating apparatus essentially comprises a hose 1 (preferably a heat hose for feeding a highly viscous material generally under heating at a temperature of 35 to 60° C.) which is connected to a feeder (not shown) for a highly viscous material such as a coat type metal sheet-reinforcing material (hereinafter simply referred to as a reinforcing material) so as to feed the reinforcing material; a pump 2; and a coating gun 3 having a slit nozzle (not shown). The reinforcing material kept being heated is band-like applied from the slit nozzle to the metal sheet of an automobile body. In this case, it is preferable to use a robot for automatic coating.

In the present invention, an optionally selected pump capable of feeding the highly viscous material may be used, and preferable examples of such a pump include constant flow pumps such as a gear pump, a plunger (or piston) pump, a rotary pump, a snake pump and the like.

Herein, firstly described is a gas injector which is one of the important features of the present invention and which is attached to the coating gun 3 to inject a gas to the band-like applied reinforcing material to thereby pressure-adhere the reinforcing material to the metal sheet so that the reinforcing material can be firmly fixed on the metal sheet of the automobile body. By using the gas injector in this way, the peeling or floating of the reinforcing material can be prevented even when the reinforcing material is applied to the vertical faces or the ceiling face of the metal sheet of the automobile body.

The gas to be used is preferably an air since it can be commonly used. It is also possible to use a heated or cooled air, a dried air or an inert gas such as nitrogen other than the air.

Examples of the injector include, but not particularly limited to, devices capable of injecting compressed gases, devices capable of injecting gases by feeding the gases with propellers or fans, etc. Above all, a device capable of injecting a compressed air is the most preferable.

The injecting angle for the gas is preferably from 15 to 85°, particularly from 30 to 60°, relative to the coating nozzle. The injecting pressure for the gas is preferably from 0.5 to 5 Kgf/cm² (from 0.05 to 0.49 MPa), particularly from 1 to 4 Kgf/cm² (from 0.10 to 0.39 MPa). When the injecting pressure is lower than 0.5 Kgf/cm² (0.05 MPa), the effect to fix the highly viscous material tends to lower. On the other hand, when the injecting pressure exceeds 5 Kgf/cm² (0.49 MPa), the highly viscous material tends to deform.

It is preferable to use an air nozzle capable of injecting a gas with a width equal to or exceeding the width of the band-like discharged reinforcing material, in order to enhance the fixing of the end portion of the band-like applied reinforcing material.

Next, the precompression control mechanism which is another important feature of the present invention, and the operation thereof will be described with reference to FIG. 1.

The precompression control mechanism comprises at least a controller 5 for the pump, such as a programmable logic controller (or PLC), and preferably further includes a pressure transmitter 4 which measures a pressure inside the hose 1 on the discharge side of the pump 2 when the application of the reinforcing material is started.

The controller for the pump to be used in the present invention functions to read the value of a pressure inside the hose on the discharge side of the pump or the value of an output from a servo amplifier load monitor described later, for a calculating operation and to output a signal for controlling the actuation of the pump in order to, adjust the inner pressure of the hose to a precompression target value. As described above, an example of the controller is a PLC, while, other than this means, a control panel may be used as the controller for the pump, when a coating robot is used (in case where the pump and the coating robot which are driven by servo motors, respectively, and which are provided by the same manufacturer are used in combination).

That is, the pressure value measured by the pressure transmitter 4 is fed to the controller 5, in which the pressure value is compared with a preset precompression target value to evaluate whether the pressure value is larger or smaller than the precompression target value. A reverse rotation signal, when larger than the target value, or a normal rotation signal, when smaller than the target value, is fed from the controller 5 to the constant flow pump 2, and the constant flow pump 2 is actuated for normal rotation or reverse rotation at a preset speed.

When the pressure inside the hose is adjusted to be equal to the precompression target value, an operation signal from the controller 5 to the constant flow pump 2 is stopped. In this way, the automatic switching operation of the constant flow pump 2 can be performed in response to the instruction from the controller 5.

In this regard, the hose 1 is preferably a heat hose capable of heating the highly viscous material to a constant temperature within a range of from 35 to 60° C. The use of the heat hose makes it possible to keep constant the viscosity of the highly viscous material and makes it hard for the coating amount to be influenced by a temperature of an external atmosphere. It also becomes possible to lower the viscosity of the viscous material so that the load on the constant flow pump 2 can be decreased.

For example, when a servo motor is used as a driving power for the constant flow pump, the load motor function of a servo amplifier can be used in place of the above pressure gauge. This case also can constitute the precompression control mechanism according to the present invention. In this case, an output from the load monitor of the servo amplifier can be used as the index of the above-described pressure, and the term of “pressure” used in the present specification also means “an output from the load monitor”.

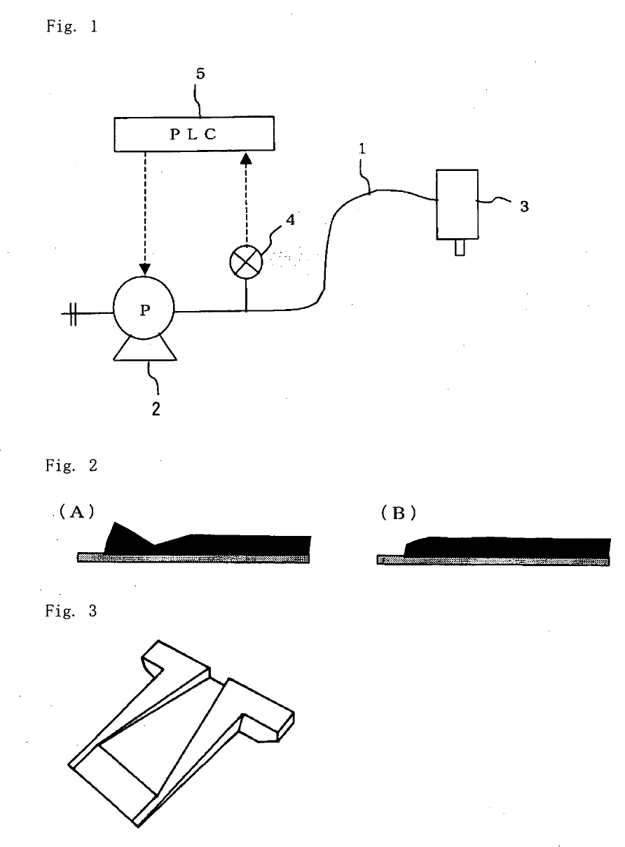

FIG. 2 shows coating states: one is a case (A) where no precompression control was not made at the start of coating, and the other is a case (B) where precompression control was made at the start of coating. Particularly in the case (A), the thickness of the end portion of the applied material increases, which is likely to induce a strain in an outer metal sheet.

When the precompression is low at the start of coating, the amount of the applied, material becomes insufficient, which is likely to lead to failure in fixing of the applied material, with the result that stain due to the sagging of the material, failure in electrodeposition coating and further, formation of rust may be induced. On the contrary, when the precompression is high at the start of coating, the increase in the amount of the applied material leads to an excess in the thickness of the applied material, which consequently causes a strain in the outer metal sheet, resulting in a poor external appearance of the metal sheet.

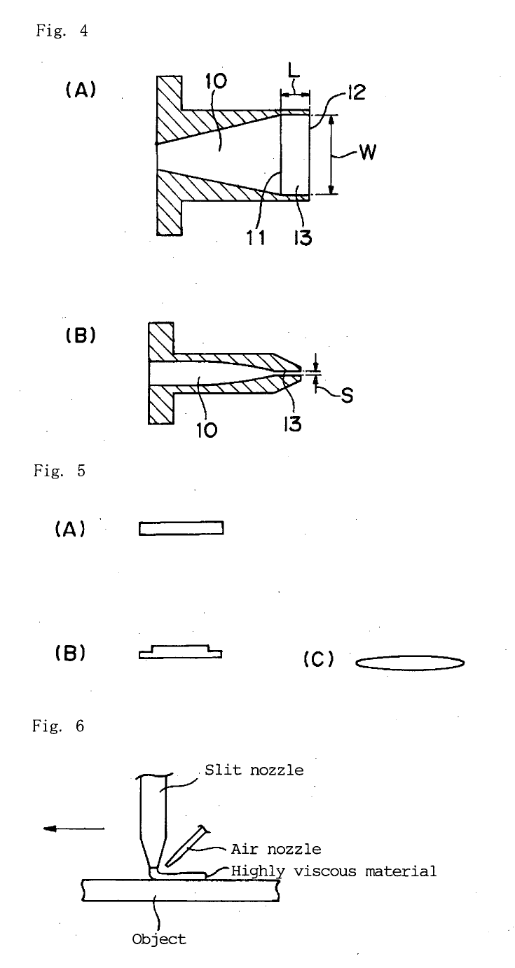

FIGS. 3 and 4 show an example of the special configuration of the slit nozzle to be used with the above-described coating gun 3. The configuration of the slit nozzle is other important feature of the present invention.

FIG. 3 shows the internal structure of the slit nozzle divided into halves. The slit nozzle shown in FIG. 3 is a parallel nozzle which has a nozzle passage 13 (whose length L from the inlet 11 to the outlet 12 is preferably from 5 to 30 mm, more preferably from 8 to 20 mm) communicating with a radial introduction passage 10, and extending from the inlet 11 to the outlet 12 with a given parallel width W (preferably from 10 to 100 mm) and having a given clearance width S (preferably from 0.5 to 5 mm), as shown in FIGS. 4(A) and 4(B). Particularly when the length L is shorter than 5 mm or longer than 30 mm, the discharge pressure from the center portion of the opening of, the nozzle becomes higher and non-even in comparison with the discharge pressures from both end portions of the opening of the nozzle, so that it becomes difficult to obtain uniform and normal coating.

The slit nozzle is preferably a heat nozzle capable of heating the highly viscous material to a constant temperature within a range of from 35 to 60° C. similarly to the above-described hose.

The slit opening of the nozzle may have a shape shown in FIG. 5(A), a shape shown in FIG. 5(B) of which both end portions are partially cut off, or an elliptical shape shown in FIG. 5(C). Particularly when the slit opening of the nozzle has a shape shown in FIG. 5(B) or 5(C), it is suitable to reapply the viscous material to parts of the applied viscous material (i.e., the cutoff portions or the end portions of the ellipse in the widthwise direction) at every one cycle (which is a period of time from the start of the first precompression to the start of the next precompression, in case where a cycle of the sequent steps of precompression, start of coating, completion of coating and precompression is repeated).

By using the slit nozzle having a special configuration as described above, the resultant applied material layer always can have a constant sectional shape which corresponds to the slit opening as shown in FIG. 5.

As described above, a reinforced metal sheet structure can be obtained by the present invention, that is, by applying a reinforcing material to a given object such as the metal sheet of an automobile body, and heating and curing the applied reinforcing material under predetermined baking conditions (generally at a temperature of from 140 to 220° C. for from 10 to 60 minutes) to thereby form a reinforcing material layer having uniform thickness and shape.

### EXAMPLES

Next, the present invention will be described in more detail by way of Example thereof.

### Example 1

### (1) Coating Apparatus

In the apparatus provided with a precompression control mechanism shown in FIG. 1, a robot was equipped with a coating gun 3 to which an injector for a compressed air and a parallel nozzle as shown in FIGS. 3 and 4 (W=30 mm, S=1.0 mm and L=11 mm) (i.e., a heat nozzle capable of controlling the temperature of a highly viscous material at 40° C.) were attached. The resultant automatic coating apparatus was used in the following method.

### (2) Coating Method

As an object, the metal sheet of an automobile body, which was a SPC steel sheet, was used; and as a highly viscous material, “Penguin Stiffener #1190” (a coat type metal sheet-reinforcing material) manufactured by SUNSTAR ENGNEERING INC. was used. The pressure inside the heat hose 1 at the start of coating was adjusted to a precompression target value of 6 MPa, and then, the robot was caused to perform automatic coating at a discharging rate of 1,200 cc/min. and at a coating rate of 400 mm/sec. and to inject a compressed air.

The compressed air was injected in the manner shown in FIG. 6. That is, the compressed air adjusted to 3.5 Kgf/cm² (0.34 MPa) was injected through an air nozzle (“Typhoon Jet” having an external size of 38 mm×65 mm×8 mm, manufactured by H. Ikeuchi & Co., Ltd.) attached at an angle of 45° to the slit nozzle which applied the highly viscous material to the object in the arrow head direction, to thereby fix the coat type metal sheet-reinforcing material to the metal sheet of the automobile body.

Next, the applied reinforcing material was heated and cured under a baking condition of 170° C. for 20 minutes to form an uniform and normal reinforcing material layer.

Thus, the reinforced metal sheet structure for the automobile body was obtained.

1. A coating apparatus for band-like applying a highly viscous material to an object, said apparatus comprising at least, a hose, a pump and a coating gun having a slit nozzle, wherein the coating gun is equipped with a gas injector which fixes the band-like applied highly viscous material to the object simultaneously with or immediately after the application of the highly viscous material.

2. A coating apparatus for band-like applying a highly viscous material to an object, said apparatus comprising at least a hose, a pump and a coating gun having a slit nozzle, wherein a precompression control mechanism is further comprised which adjusts the value of a measured pressure inside the hose on the discharge side of the pump to a preset precompression target value to thereby enable an automatic switching operation of the pump, and wherein the precompression control mechanism includes at least a controller for the pump.

3. A coating apparatus for band-like applying a highly viscous material to an object, said apparatus comprising at least a hose, a pump and a coating gun having a slit nozzle, wherein the slit nozzle is a parallel nozzle which has a nozzle passage communicating with a radial introduction passage, and extending from an inlet to an outlet with a constant parallel width W and having a constant clearance width S.

4. The coating apparatus according to claim 3, wherein the constant parallel width W is from 10 to 100 mm; the constant clearance width S, from 0.5 to 5 mm; and the length L from the inlet 11 to the outlet 12, from 5 to 30 mm.

5. A coating apparatus for band-like applying a highly viscous material to an object, said apparatus comprising at least a hose, a pump and a coating gun having a slit nozzle, and being characterized in that
the coating gun is equipped with a gas injector which fixes the band-like applied highly viscous material to the object simultaneously with or immediately after the application of the highly viscous material;
a precompression control mechanism is further comprised which adjusts the value of a measured pressure inside the hose on the discharge side of the pump to a preset precompression target value to thereby enable an automatic switching operation of the pump; and the precompression control mechanism includes at least a controller for the pump; and
the slit nozzle is a parallel nozzle which has a nozzle passage communicating with a radial introduction passage, and extending from an inlet to an outlet with a constant parallel width W and having a constant clearance width S.

6. The coating apparatus according to claim 1, for use in automatic coating by a robot.

7. A method for band-like applying a highly viscous material to an object, using the coating apparatus defined in claim 1.

8. The method according to claim 7, wherein the highly viscous material is a coat type metal sheet-reinforcing material, and wherein the object is the metal sheet of an automobile body.

9. A reinforced metal sheet structure obtained by applying a reinforcing material to a metal sheet by the method defined in claim 8, and heating and curing the applied reinforcing material on the metal sheet.

10. A method for manufacturing a coated article, comprising the steps of feeding a highly viscous material to a coating gun 3 through a hose 1 and a pump 2, and band-like applying the highly viscous material to an object from the slit nozzle of the coating gun 3, wherein a gas injector attached to the coating gun is used to fix the band-like applied highly viscous material to the object simultaneously with or immediately after the application of the highly viscous material.

11. The method according to claim 10, wherein an automatic switching operation of the pump is performed by adjusting the value of a measured pressure inside the hose on the discharge side of the pump to a preset precompression target value via a controller 5 for the pump.

12. The method according to claim 10, wherein the slit nozzle is a parallel nozzle which has a nozzle passage communicating with a radial introduction passage, and extending from an inlet to an outlet with a constant parallel width W and having a constant clearance width S.
